(19) United States
(12) Patent Application Publication
(10) Pub. No.: US 2026/0078845 A1
(43) Pub. Date: Mar. 19, 2026

(54) Trace Routing Fastener

(71) Applicant: Illinois Tool Works Inc., Glenview, IL (US)

(72) Inventor: Joel R. Lee, Peotone, IL (US)

(21) Appl. No.: 19/329,994

(22) Filed: Sep. 16, 2025

Related U.S. Application Data
(60) Provisional application No. 63/696,408, filed on Sep. 19, 2024.
(60) Provisional application No. 63/780,561, filed on Mar. 31, 2025.

(51) Int. Cl. F16L 3/123; F16B 9/02

(52) U.S. Cl. CPC F16L 3/123; F16B 9/02

(57) ABSTRACT

The disclosure describes a fastening system for securing components, such as tubes or cables, to a larger structure, like a vehicle body panel. The system includes a base structure that holds the components and a lock pin that secures the base structure in place. The lock pin has a head with a movable tab that covers an installation indicator when the pin is not fully seated. As the lock pin is pushed into its final position, the tab pivots out of the way, revealing the installation indicator, which can be read by a visual quality system. This arrangement allows operators or automated systems to quickly verify whether the lock pin has been correctly installed. The tab and indicator combination provides a visual and tactile confirmation of proper installation, helps prevent assembly errors, and can integrate with automated inspection systems.

### RELATED APPLICATION

The present application claims priority to U.S. Provisional Patent Application Nos. 63/696,408, filed Sep. 1, 2024, and 63/780,561, filed Mar. 31, 2025, each entitled “Trace Routing Fastener,” each of which is hereby incorporated by reference in its entirety.

### BACKGROUND

Automotive components require fastening techniques that are simple to manufacture and assemble. Further, fastening techniques should above all be reliable and efficient. In some instances, objects need to be secured to the vehicle to mitigate movement and/or shifting during operation, which can result in damage or kinking to the object. For example, tube, hoses, wires, and other objects are often secured to the vehicle components via fasteners. When a fastener is installed incorrectly such that the fastener is not fully inserted into the opening, the fastener can detach and/or the object being fastened can become damaged or loose. Similarly, when an object is attached incorrectly to a fastener, the object can detach from the fastener or become damaged or loose.

Conventional fastening or assembly systems often require the use of bolts and heavy tools during installation on assembly lines. This not only increases the overall weight of the system but also introduces complexity, higher labor demands, and potential delays in the manufacturing process.

Therefore, it would be desirable to provide an installation indicator to enhance proper installation of the object relative to the fastener and/or the fastener relative to the first component during assembly.

### SUMMARY

The present disclosure relates generally to a fastening system to form a connection between the first and second components, such as tubes and panels. More specifically, a fastener with an installation indicator to enhance proper installation of the object relative to the fastener and/or the fastener relative to the first component during assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIGS. 1a and 1b illustrate a fastening system configured to secure one or more second components relative to a first component via a fastener assembly having a lock pin and a base structure, in accordance with a first aspect of this disclosure.

FIGS. 2a and 2b illustrate perspective views of the fastener assembly in, respectively, a first assembled position and a second assembled position.

FIGS. 2c and 2d illustrate side elevation views of the fastener assembly in, respectively, a first assembled position and a second assembled position.

FIGS. 2e and 2f illustrate side elevation cross-sectional views of the fastener assembly taken along cutline A-A (FIG. 2a) in, respectively, the first assembled position and the second assembled position.

FIGS. 2g and 2h illustrate, respectively, perspective and cross-sectional perspective views of the fastener assembly taken along cutline B-B (FIG. 2g) in the first assembled position.

FIGS. 2i and 2j illustrate, respectively, perspective and cross-sectional perspective views of the fastener assembly taken along cutline B-B (FIG. 2g) in the second assembled position.

FIGS. 2k and 2l illustrate top plan views of the fastener assembly in, respectively, the first assembled position and the second assembled position.

FIGS. 3a and 3b illustrate a fastening system configured to secure one or more second components relative to the first component via a fastener assembly having a lock pin and a base structure, in accordance with a second aspect of this disclosure.

FIGS. 4a and 4b illustrate perspective views of the fastener assembly in, respectively, a first assembled position and a second assembled position.

FIGS. 4c and 4d illustrate side elevation views of the fastener assembly in, respectively, a first assembled position and a second assembled position.

FIGS. 4e and 4f illustrate side elevation cross-sectional views of the fastener assembly taken along cutline C-C (FIG. 4g) in, respectively, the first assembled position and the second assembled position.

FIGS. 4g and 4h illustrate, respectively, perspective and cross-sectional perspective views of the fastener assembly taken along cutline C-C (FIG. 4g) in the first assembled position.

FIGS. 4i and 4j illustrate, respectively, perspective and cross-sectional perspective views of the fastener assembly taken along cutline C-C (FIG. 4g) in the second assembled position.

FIGS. 4k and 4l illustrate top plan views of the fastener assembly in, respectively, the first assembled position and the second assembled position.

FIGS. 5a and 5b illustrate, respectively, assembly and assembled isometric views of the fastener assembly with the first component and a visual quality system.

FIG. 6a illustrates a fastening system configured to secure one or more second components relative to a first component by means of a fastener assembly including a lock pin and a base structure, in accordance with a third aspect of the present disclosure.

FIG. 6b shows a cross-sectional view of the fastener assembly taken along cutline D-D of FIG. 6a, and FIG. 6c presents an exploded assembly view of the fastener assembly corresponding to FIGS. 6a and 6b.

FIG. 7a illustrates a fastening system configured to secure one or more second components relative to a first component by means of a fastener assembly including a lock pin and a base structure, in accordance with a fourth aspect of the present disclosure.

FIG. 7b shows a cross-sectional view of the fastener assembly taken along cutline E-E of FIG. 7a, and FIG. 7c presents an exploded assembly view of the fastener assembly corresponding to FIGS. 7a and 7b.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side”and “second side”do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC). The processor may be coupled to or integrated with a memory device. The memory device can be any suitable type of computer memory or any other type of electronic storage medium, such as, for example, read-only memory (ROM), random access memory (RAM), cache memory, compact disc read-only memory (CD-ROM), electro-optical memory, magneto-optical memory, programmable read-only memory (PROM), erasable programmable read-only memory (EPROM), electrically erasable programmable read-only memory (EEPROM), a computer-readable medium, or the like.

The term “and/or” means any one or more of the items in the list joined by “and/or. ” As an example, “x and/or y” means any element of the three-element set {(x), (y), (x, y)}. In other words, “x and/or y” means “one or both of x and y. ” As another example, “x, y, and/or z” means any element of the seven-element set {(x), (y), (z), (x, y), (x, z), (y, z), (x, y, z)}. In other words, “x, y, and/or z” means “one or more of x, y, and z. ” The disclosed fastener assembly in accordance with an aspect of the disclosure addresses deficiencies in the art through an all-plastic construction that eliminates the need for tools during assembly, thereby simplifying the installation process and reducing weight. The design further enables visual or automated assembly verification through integrated features compatible with vision systems. Specifically, the design incorporates scannable elements that allow for real-time confirmation of proper assembly without physical inspection or manual validation.

In one example, a fastening system configured to secure one or more second components to a first component comprises: a base structure defining a grommet portion and a carrier portion, the carrier portion including a fiducial support having an installation indicator; and a lock pin comprising a shank and a head, the head including a fixed portion and a tab pivotally coupled to the fixed portion, wherein the tab is movable between a first position and a second position relative to the installation indicator, and wherein the tab is configured to pivot upon engagement with the fiducial support during advancement of the lock pin to a fully seated position, thereby allowing the installation indicator to be read by a visual quality system.

In some examples, the tab is coupled to the fixed portion via one or more film hinges.

In some examples, in the first position, the tab at least partially covers the installation indicator to indicate that the lock pin is not fully seated.

In some examples, the base structure comprises one or more flex tab features configured to engage a window in the first component, the flex tab features deflecting during insertion and returning to an extended position to retain the base structure.

In some examples, the fiducial support is positioned at an angle relative to the carrier portion to optimize detection of the installation indicator by the visual quality system.

In some examples, the tab is coupled along an exterior edge of the fixed portion.

In some examples, movement of the tab to the second position provides a visual confirmation of proper installation of the lock pin relative to the base structure.

In some examples, the fastening system, further comprises a strap and a strap opening in the carrier portion, the strap configured to secure the one or more second components to the carrier portion.

In another example, a lock pin assembly for use with a base structure comprising a fiducial support carrying an installation indicator, the lock pin assembly comprising: a shank; a head including a fixed portion and a tab pivotally coupled to the fixed portion; and wherein the tab is movable between a first position and a second position relative to the installation indicator, and wherein the tab is configured to pivot upon engagement with the fiducial support during advancement of the lock pin to a fully seated position, thereby allowing the installation indicator to be read by a visual quality system.

In some examples, the head further comprises a pair of flexible arms extending from the shank, each flexible arm having a first notch and a second notch configured to engage a pawl on the base structure to maintain the lock pin in one of a shipping position and a fully installed position.

In some examples, the tab is configured to pivot upon engagement with the fiducial support.

In some examples, the tab is pivotable about a pivot axis formed along an exterior edge of the fixed portion.

In some examples, the installation indicator comprises a barcode, QR code, or another machine-readable symbol.

In some examples, the fiducial support is a block-shaped structure at least partially received by a window in the fixed portion of the head of the lock pin.

In yet another example, a fastening system configured to secure one or more second components to a first component comprises: a base structure comprising a carrier portion and one or more pawls; a lock pin comprising a shank and a head, the head including a fixed portion, a tab pivotally coupled to the fixed portion, and a pair of flexible arms extending from the shank, each flexible arm having a first notch and a second notch configured to engage the pawl to maintain the lock pin in a shipping position and a fully installed position, respectively; and wherein the tab is movable between a first obstructive position and a second non-obstructive position relative to an installation indicator mounted on a fiducial support of the carrier portion, the tab pivoting upon engagement with the fiducial support as the lock pin is advanced to a fully seated position.

In some examples, the flexible arms are configured to deflect inward to disengage the pawl from the first notch during advancement of the lock pin.

In some examples, the pawl engages the second notch of the flexible arms to lock the lock pin in the fully installed position.

In some examples, the fiducial support is positioned to stabilize the tab and maintain a consistent angle of the installation indicator for visual detection.

In some examples, improper seating of the lock pin prevents the tab from fully pivoting, resulting in the installation indicator being at least partially obstructed.

In some examples, the base structure further comprises a grommet portion defining a grommet opening configured to receive the shank of the lock pin.

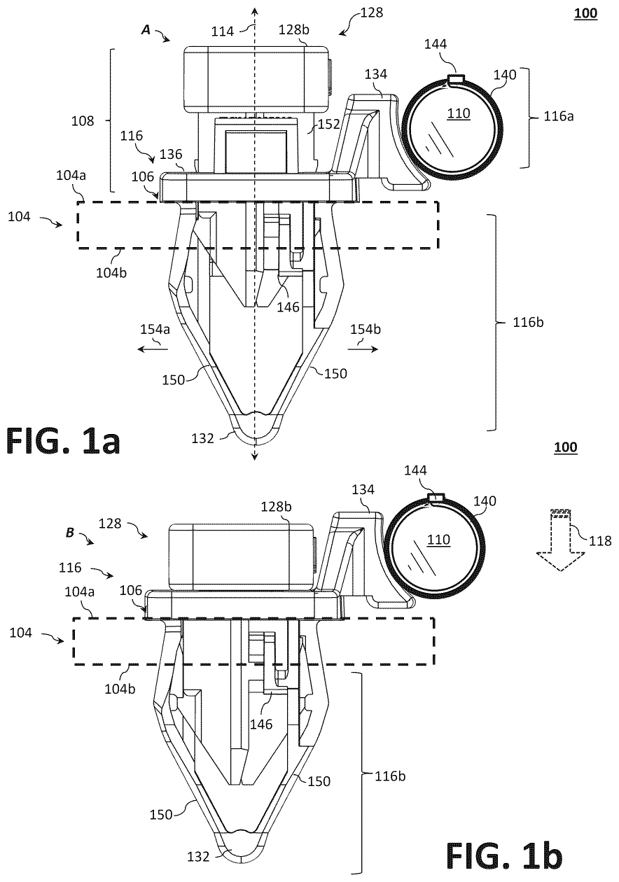

FIGS. 1a and 1b illustrate a fastening system 100 configured to secure one or more second components 110 relative to a first component 104 via a fastener assembly 102 that includes a lock pin 108 and a base structure 116, in accordance with a first aspect of this disclosure. The fastening system 100 generally includes a fastener assembly 102 that is a multi-component assembly configured for installation into a first component 104. The one or more second components 110 can attach to a portion of the fastener assembly 102. The first component 104 defines an opening 106 configured to receive and retain the fastener assembly 102.

The first component 104 includes an A-side surface 104a (e.g., exterior surface) and a B-side surface 104b (e.g., interior surface). The one or more second components 110 are mounted to the A-side surface 104a via the fastener assembly 102. The first component 104 may comprise structural or body elements of a vehicle, such as doors, pillars (A-, B-, or C-pillars), dashboard components, seat frames, center consoles, fenders, sheet metal framework, or similar elements.

Depending on the application, the first component 104 may be formed from metal, metal alloys, synthetic or semi-synthetic polymers (e.g., ABS or PVC), composite materials (e.g., fiberglass), or combinations thereof. The opening 106 may be integrally formed during manufacturing and is generally rectangular in the illustrated example, though other geometries —such as circular, oval, triangular, or other quadrilateral openings—are also contemplated. The second components 110 may include brake lines, fuel lines, electrical cables, pipes, or other tubular or elongate structures.

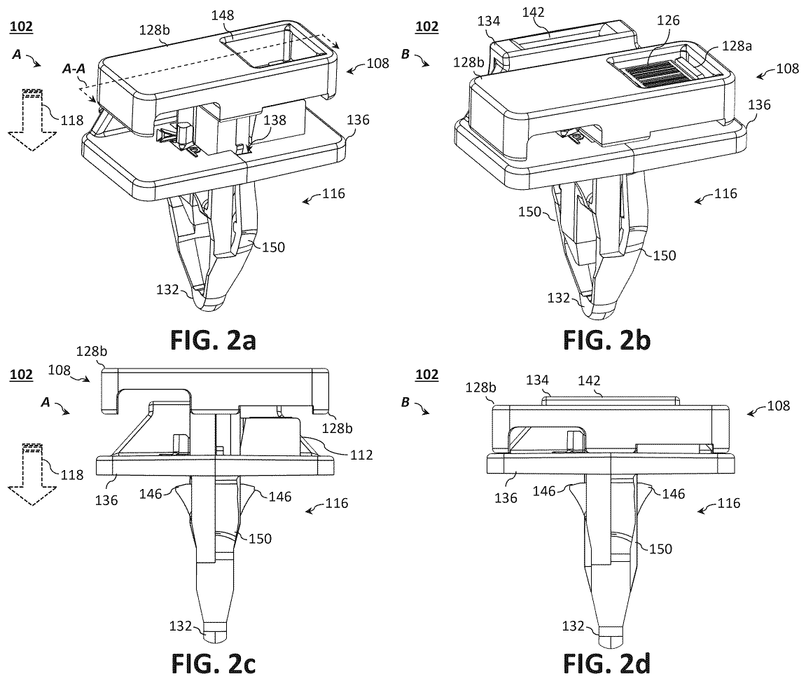

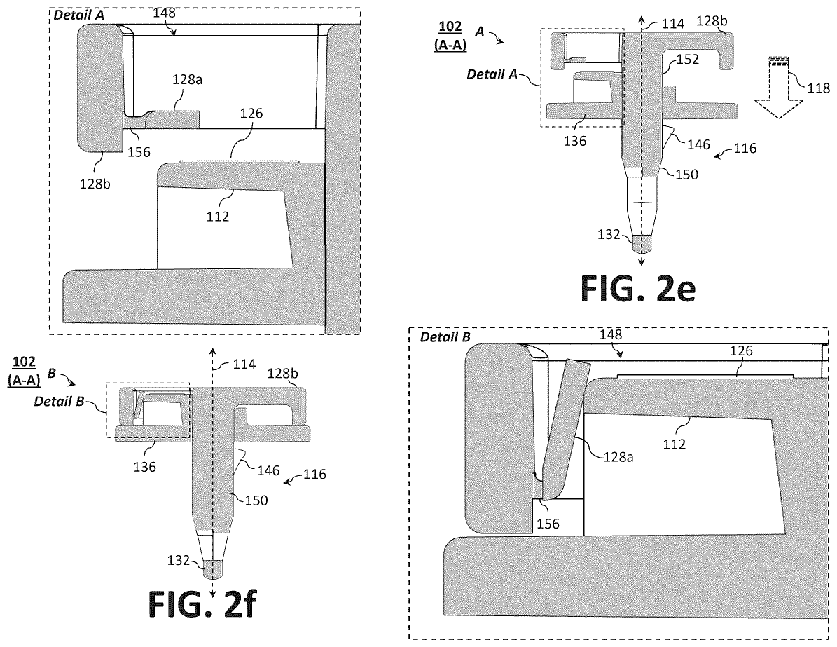

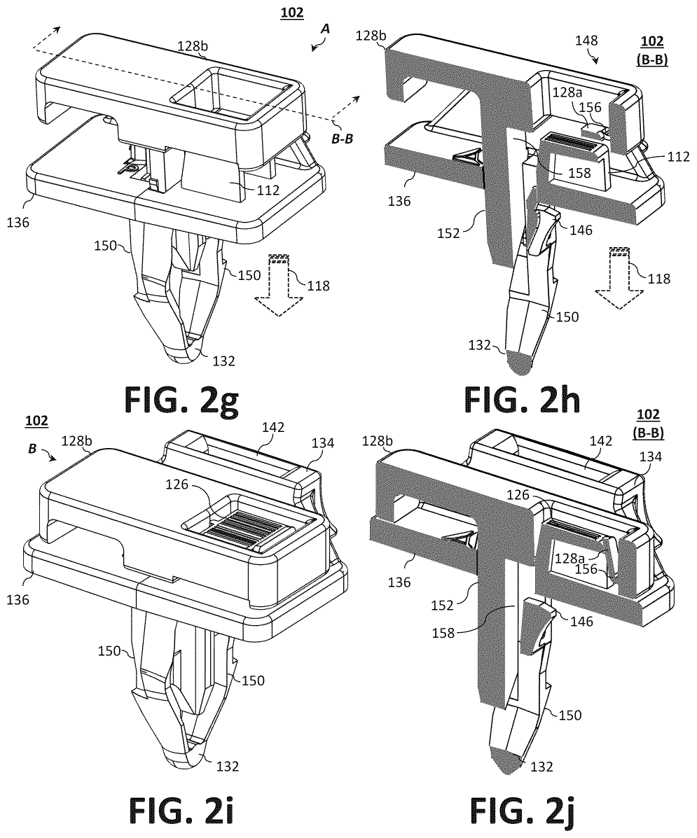

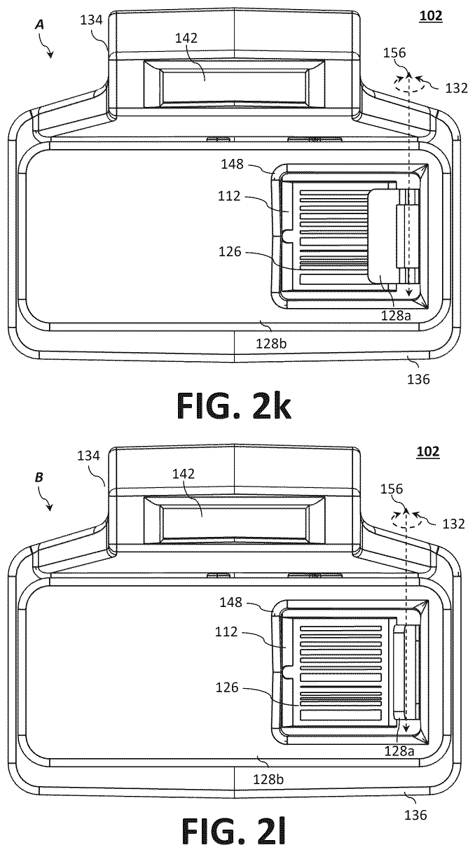

Details of the fastener assembly 102 are illustrated in greater detail at FIGS. 2a through 2l. Specifically, FIGS. 2a and 2b show perspective views of the fastener assembly 102 in a first assembled position (Position A) and a second assembled position (Position B), respectively. FIGS. 2c and 2d show side elevation views of the fastener assembly 102 in the same two positions. FIGS. 2e and 2f depict side elevation cross-sectional views of the fastener assembly 102 taken along cutline A-A of FIG. 2a in positions A and B, respectively. FIGS. 2g and 2h depict, respectively, perspective and cross-sectional perspective views of the fastener assembly 102 taken along cutline B-B of FIG. 2g in Position A. FIGS. 2i and 2j depict, respectively, perspective and cross-sectional perspective views of the fastener assembly 102 taken along cutline B-B of FIG. 2g in Position B. FIGS. 2k and 2l show top plan views of the fastener assembly 102 in positions A and B, respectively.

The illustrated fastener assembly 102 comprises multiple components, including a lock pin 108 and a base structure 116. In some examples, the fastener assembly 102 can be preassembled in the first assembled position to serve as a shipped, pre-install configuration (Position A). The fastener assembly 102 also includes one or more features on the base structure 116 that facilitate securing the second component 110 thereto via a strap 140. For example, the base structure 116 includes a carrier portion 116a and a fastener portion 116b. The carrier portion 116a and the fastener portion 116b can be formed as a single, unitary component. Alternatively, the fastener portion 116b may be attached to the carrier portion 116a using adhesives, welding, mechanical fasteners, or other joining methods.

Additional features, such as ribs, wings, liners, padding, etc., may be incorporated to mitigate vibration, noise, or rattle (BSR) between the fastener assembly 102 and the first component 104 and/or the second component 110. The carrier portion 116a is configured to engage one or more second components 110 and secure them relative to the first component 104. In the illustrated example, the carrier portion 116a includes a payload portion 134 and a grommet portion 136.

The payload portion 134 interfaces with the second component 110, while the grommet portion 136 defines a grommet opening 138 configured to receive at least a portion of the lock pin 108. The grommet portion 136 further comprises a fiducial support 112 that carries an installation indicator 126, such as a barcode or QR code, which can be detected by a visual quality system 120. In the illustrated example, the fiducial support 112 is formed as a generally block-shaped structure with an upper surface having the installation indicator 126 on an exterior surface thereof. The fiducial support 112 may be hollow or partially cored out to conserve material and reduce weight. The fiducial support 112 is dimensioned to correspond to a window 148 formed in the fixed portion 128b of the lock pin head 128. During assembly, the fiducial support 112 is guided into and at least partially received by the window 148.

In the fully seated condition (Position B), the top surface of the fiducial support 112, which carries the installation indicator 126, aligns with and/or is substantially flush with the surrounding top surface of the fixed portion 128b, as illustrated in FIG. 2i. This block-and-window engagement between the fiducial support 112 and window 148 provides several functional benefits. First, it stabilizes the fiducial support 112 relative to the lock pin 108, preventing lateral shifting or rotation that might otherwise misalign the installation indicator 126. Second, it ensures repeatable and consistent placement of the installation indicator 126 in a known plane and orientation, which improves the accuracy and reliability of detection by the visual quality system 120. Third, the positive seating of the fiducial support 112 within the window 148 provides a tactile and visual confirmation of proper installation, further reducing assembly errors. Finally, the use of a hollow or lightweight block structure reduces overall part cost and mass while still providing sufficient rigidity to support and protect the installation indicator 126 during handling and service.

The fastener portion 116b is configured to connect the carrier portion 116a to the first component 104. In the illustrated example, the fastener portion 116b is configured to snap into the opening 106 of the first component 104 during installation.

In the illustrated example, a strap opening 142 is defined through the payload portion 134. There can be one or more strap openings 142. A strap 140 is threaded through the strap opening 142 and looped around the one or more second components 110, with the free ends fastened using a strap fastener 144. Suitable strap fasteners 144 may include ratcheting mechanisms, latches, snaps, clips, hook-and-loop fasteners, or cable ties (e.g., zip ties). While a single strap 140 is illustrated, additional or fewer straps 140 and strap openings 142 may be used depending on design requirements and the number of second components 110 to be secured.

The dimensions of the carrier portion 116a can be modified to accommodate the necessary number of straps or components. Although described in the context of securing tubes, the fastener assembly 102 may be used to attach various other objects. During installation, a leading end 132 of the fastener portion 116b is inserted into the opening 106 of the first component 104 in the direction shown by arrow 118. The fastener portion 116b extends generally perpendicularly to the carrier portion 116a and includes a central longitudinal axis 114. In the illustrated example, the fastener portion 116b comprises a pair of resilient legs 150 attached to the underside of the carrier portion 116a. The distal ends of the resilient legs 150 converge and are connected at the leading end 132. The fastener portion 116b can further comprise one or more features formed on the exterior surfaces of the resilient legs 150.

Commonly owned U.S. patent application Ser. No. 19/233,139, which was filed on Jun. 10, 2025, and is titled “Trace Routing Fastener” discloses a fastener portion 116b with steps extending circumferentially or partially circumferentially around the leg surface and includes a ledged or shoulder-like feature configured to catch or engage the internal surface of the opening 106 formed in the first component 104. A multi-step engagement helps ensure a firm fit, compensates for dimensional variation, and mitigates buzz, squeak, and rattle (BSR) noise during use or vibration. U.S. patent application Ser. No. 19/233,139 is hereby incorporated by reference in its entirety as if fully set forth herein.

The lock pin 108 and base structure 116 may each be formed as unitary components using plastic injection molding or additive manufacturing. In additive examples, components may be fabricated via fused deposition modeling (FDM), stereolithography (SLA), selective laser sintering (SLS), or other 3D printing methods, offering precision and flexibility, particularly for complex geometries and low-volume production. Additive manufacturing processes consider horizontal resolution (X-Y plane) and vertical resolution (Z-axis layer thickness). Horizontal resolution typically ranges from 50-100μm (510-250 DPI), while vertical resolution can range from 16-100μm (1,600-250 DPI). Higher resolutions yield finer detail but increase production time. Different portions of the fastener assembly 102 may be printed at different resolutions based on functional or design needs.

Improper installation of the second component 110 or the fastener assembly 102 may lead to detachment or misalignment. Improper attachment may also damage or loosen the first component 104. To support installation tracking, the lock pin 108 includes a head 128 affixed to shank 152. The head 128 comprises a fixed portion 128b and one or more tabs 128a that can pivot relative to the fixed portion about a pivot axis 130. The tab 128a is connected to the fixed portion 128b via one or more film hinges 156, which permits pivoting movement. In the illustrated example, the tab 128a is connected to the fixed portion 128b via a pair of spaced-apart film hinges 156, which is best illustrated in FIG. 2k. In the illustrated example, the head 128 includes a fixed portion 128b having a window 148 with a single tab 128a hingedly coupled therein. During assembly, the tab 128a is biased or pivoted via the fiducial support 112.

When the head 128 is fully seated (Position B), the tab 128a pivots upwardly and away such that the installation indicator 126 is not obstructed by the tab 128a, allowing the visual system 120 to fully read the installation indicator 126. In an intermediate or pre-install positions (Position A), the tab 128a are angled to at least partially obstruct the installation indicator 126, making the installation indicator 126 unreadable or at least reflecting that it is partially obstructed by the tab 128a. Contact with the fiducial support 112 causes the tab 128a to pivot upward as the lock pin 108 is pushed into place.

If the lock pin 108 is improperly installed, the tab 128a at least partially obstructs the installation indicator 126, resulting in a misaligned position. This misalignment prevents the visual quality system 120 from reading (or fully reading) the installation indicator 126, signaling improper assembly. In some examples, an installation indicator can additionally (or alternatively) be positioned on the tab 128a. In such an example, the visual quality system 120 can read the installation indicator positioned on the tab 128a or use it to determine an angle of the tab 128a, thus being able to determine whether and the degree to which the lock pin 108 is positioned at a position between Position A and Position B.

The fastener assembly 102 is configured to be mounted to a first component 104, such as a vehicle frame, after it has been pre-attached to a second component 110 (e.g., a wire harness) using a strap 140, such as a zip tie or cable strap. During installation, the fastener assembly 102 can first be attached to a first component bundle using strap 140.

As shown in FIGS. 2a and 2c, during shipping and prior to installation, the lock pin 108 is maintained in a part-in-assembly (PIA) position relative to the base structure 116. This is achieved through engagement between a lock tab, located on the lock pin 108, and a corresponding feature on the base structure 116. The lock tab can be formed as a fixed lateral protrusion extending from the shank 152 of the lock pin 108. The lock tab is configured to produce an interference fit with the base structure 116, thereby temporarily holding the lock pin 108 in its first (PIA) position (Position A). For example, lock tab may engage either an inner wall of the grommet opening 138 or a structural element, such as a notch, recess, or ledge, within a cavity or recess located between a pair of resilient legs 150 of the base structure 116.

The base structure 116 can further include one or more flex tab features 146, which are formed integrally with, or attached to, the resilient legs 150. These flex tab features 146 are designed to retain the base structure 116 within a first component 104 by engaging an opening 106 when the fastener system is in its second assembled position. These flex tab features 146 are located near the proximal ends of the legs, close to the point where each leg connects to the carrier portion 116a.

Each flex tab feature 146 comprises a sloped body portion, such as a triangular or wedge-shaped fin, and a movable base portion, which is resiliently or pivotally coupled to its respective resilient leg 150. These flex tab features 146 are designed to deflect toward or away from the central longitudinal axis 114 during insertion into the opening 106. For instance, as base structure 116 is pressed into the first component 104, an outer edge of the opening 106 applies an inward biasing force onto the sloped portion, causing the tab 146 to temporarily retract.

Once the flex tab features 146 are removed from the opening 106, the flex tab features 146 resiliently return to their original extended positions. A portion of the sloped body, such as its upper edge, then abuts against a surface of the first component 104 (e.g., an interior sidewall of the opening 106), mitigating back-out of the base structure 116. The lock pin 108 is then advanced through the grommet opening 138 until it reaches a second assembled position.

Prior to full installation, the visual quality system 120 cannot read the installation indicator 126 positioned on the fiducial support 112 (or, at minimum, can detect that the installation indicator 126 is at least partially obstructed). Once fully seated, the resilient legs 150 splay outward (see arrows 154a and 154b, FIG. 1a), anchoring the base structure 116 inside the first component 104. Simultaneously, the tab 128a moves out of the way of the installation indicator 126, enabling the visual system 120 to verify installation. During final installation of the fastener assembly 102 into the first component 104, continued pressure (direction of arrow 118) causes the lock pin 108 to advance into its fully seated position.

Additionally, the lock tab on the lock pin 108 engages with protrusion features on the base structure 116. These features cooperate to prevent axial back-out of the lock pin 108 from either the shipping (Position A) or final installed (Position B) positions, thereby improving retention and overall system robustness. In some aspects, the lock pin 108 includes a channel 158 formed along at least a portion of the shank 152. This channel aligns with the flex tab features 146 during insertion, allowing them to freely move toward and away from the axis 114.

In configurations where flex tabs 146 are asymmetrically positioned, the channel 158 may also be asymmetrically located to match. In other designs, the channel 158 may be omitted. In such cases, the shank 152 obstructs the inward motion of the flex tab features 146, holding them in an outwardly deployed state. This locked-out configuration may be desirable where maximum mechanical retention, structural rigidity, or vibration resistance is required, such as in aerospace, automotive, or structural panel applications.

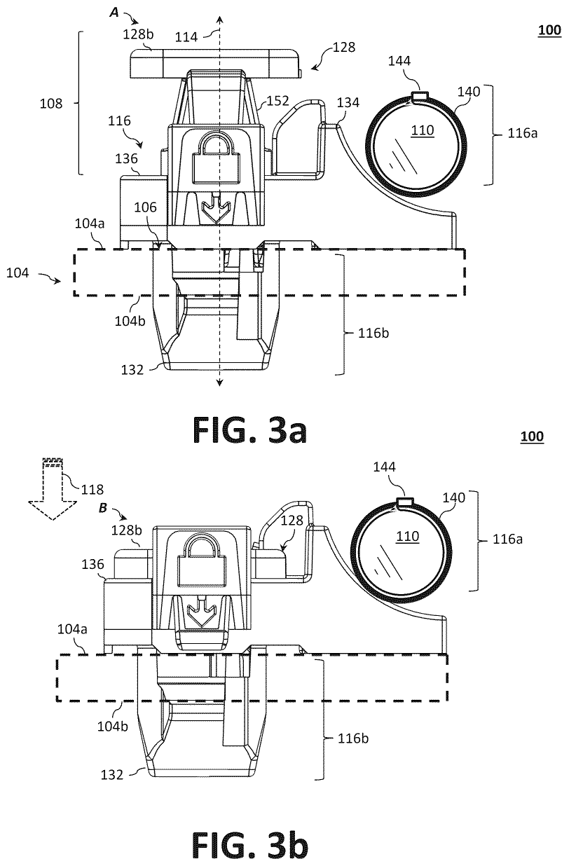

FIGS. 3a and 3b illustrate a second example of the fastening system 100, configured to secure one or more second components 110 relative to the first component 104 via a fastener assembly 102 that includes a lock pin 108 and a base structure 116, in accordance with a second aspect of this disclosure.

The fastener assembly 102 of FIGS. 3a and 3b is generally similar in structure and function to the fastener assembly described above with reference to FIGS. 1a through 2l. Accordingly, to avoid redundancy, emphasis in this section will be placed on the differences between the two examples. Unless otherwise noted, the various features disclosed and described in connection with the first example provide a similar or equivalent function in the present example and, for brevity, will not be repeated in detail. In this second example, the tab 128a of the lock pin 108 is positioned such that it engages a fiducial support 112 located on or adjacent to the payload portion 134.

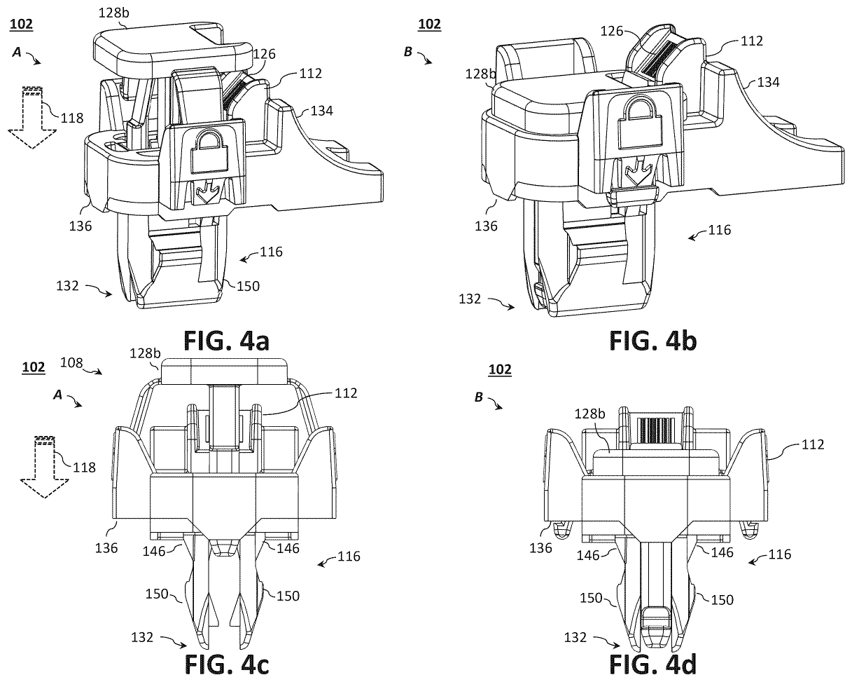

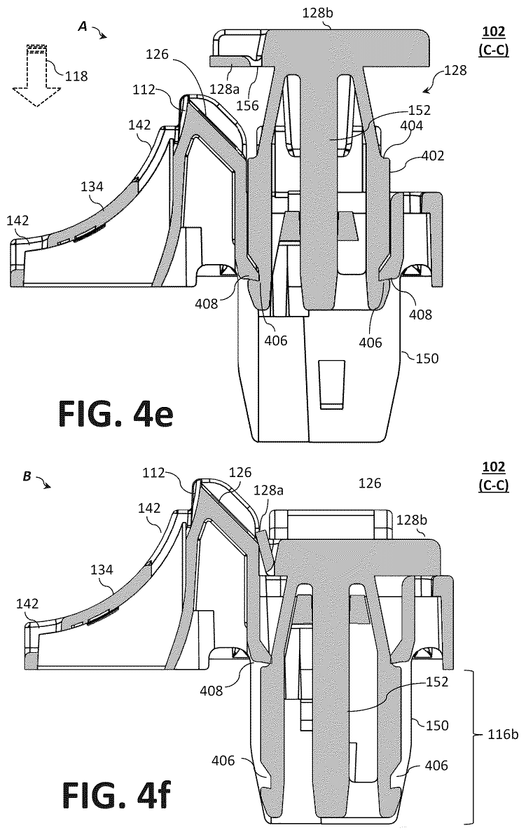

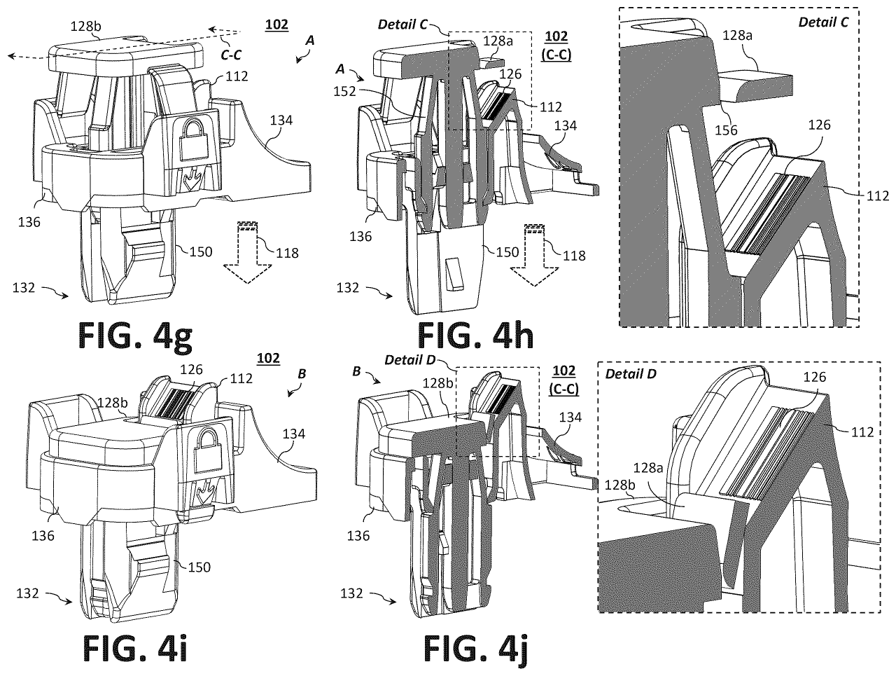

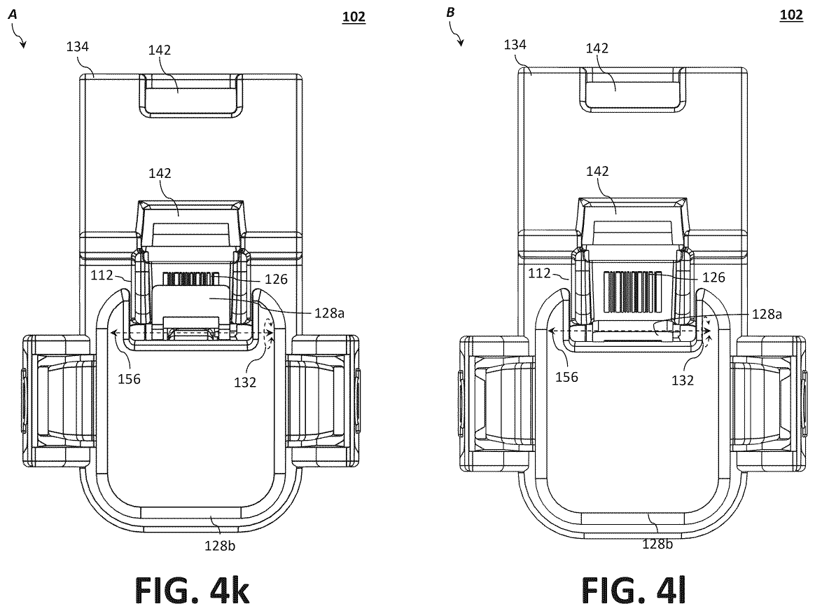

FIGS. 4a and 4b show perspective views of the fastener assembly 102 in positions A and B, respectively. FIGS. 4c and 4d show side elevation views in positions A and B, respectively. FIGS. 4e and 4f depict side elevation cross-sectional views taken along cutline C-C of FIG. 4g in positions A and B, respectively. FIGS. 4g and 4h depict, respectively, perspective and cross-sectional perspective views taken along cutline C-C of FIG. 4g in Position A. FIGS. 4i and 4j depict, respectively, perspective and cross-sectional perspective views taken along cutline C-C of FIG. 4g in Position B. FIGS. 4k and 4l show top plan views in positions A and B, respectively.

In this second example, the lock pin head 128 includes a shank 152 flanked on either side by a pair of flexible arms 402. Each flexible arm 402 is formed with a first notch 406 and a second notch 404, which function as engagement surfaces for a pawl 408 mounted on the base structure 116. The first notch 406 is configured to receive the pawl 408 and secure the lock pin 108 in the shipping or pre-install position (Position A). The second notch 404 is configured to engage the pawl 408 once the lock pin 108 has been fully installed, thereby securing the lock pin in the final assembled position (Position B).

During installation, the lock pin 108 is pushed in the direction indicated by arrow 118. The applied force causes the shank 152 and the flanking flexible arms 402 to deflect inward, overcoming the engagement of the pawl 408 with the first notch 406. As the lock pin 108 continues to advance, the pawl 408 slides along the flexible arm 402 until it seats in the second notch 404, thereby locking the pin in the installed position (Position B).

In this example, the pivoting tab 128a is coupled to the fixed portion 128b along an exterior edge of the fixed portion, rather than being hinged into a window as in the first example. This exterior-edge coupling allows the tab 128a to pivot upward and out of the way during installation, clearing the line of sight for the installation indicator 126.

The installation indicator 126 is mounted on a fiducial support 112, which is angled to position the indicator optimally for reading and analysis by a visual quality system 120. This arrangement ensures that the visual system can reliably detect proper installation, while improper seating of the lock pin 108 or incomplete movement of the tab 128a will be immediately indicated by a misread or partially obstructed installation indicator 126.

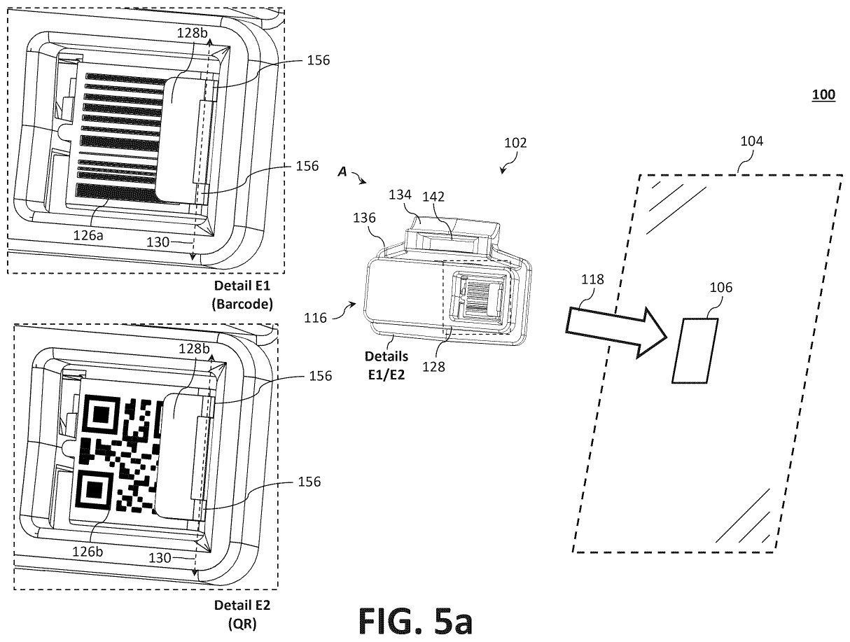

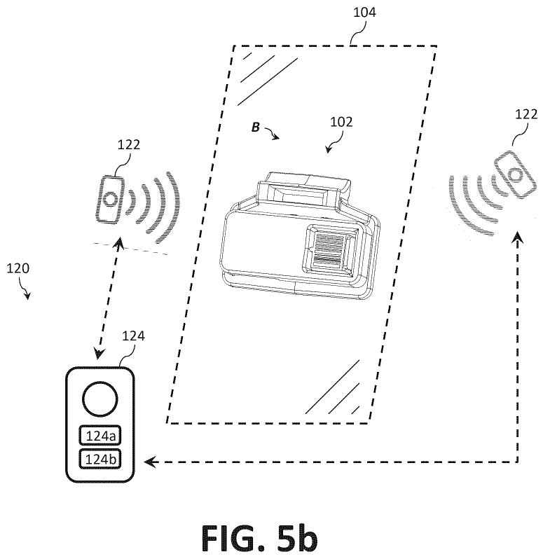

FIGS. 5a and 5b illustrate, respectively, assembly and assembled isometric views of the fastener assembly 102 with the first component 104 and a visual quality system 120. The fastening system 100 can be used in conjunction with a visual quality system 120, which includes a reader 122 and a computer 124. The reader 122, which may be connected to the computer 124 via a wired or wireless connection, is positioned adjacent to the fastener assembly 102 and/or the first component 104 to monitor the assembly process, including the insertion of a second component 110.

As with the preceding examples, features not specifically highlighted here may be understood to provide the same or equivalent function as previously described, and for brevity, will not be repeated. In some examples, the head 128 is designed so that one or more installation indicators 126 remain hidden from the visual quality system 120 until the lock pin 108 is fully assembled. Specifically, if the lock pin 108 is not completely seated, the tab 128a will not lie flush with the fixed portion 128b, and the system either cannot detect the installation indicator 126 or detects an incorrect angle.

In either case, the visual quality system 120 registers an error or anomaly. Based on data from the installation indicator 126, the computer 124 (via processor 124a and memory 124b) can determine whether the fastener assembly 102 is properly installed into the first component 104. If improper installation is detected, the system can alert an operator, such as via a portable communication device. In automated or robotic applications, the robot may automatically repeat the assembly process to correct the error.

While a single installation indicator 126 is illustrated, multiple indicators may be used to enhance redundancy or accuracy by providing several positional data points. Additionally, indicators can be located elsewhere on the fastener assembly 102, such as on a sidewall of the carrier portion 116a, either as a supplement to or replacement for the head-mounted indicator. The installation indicator 126 is affixed to the fiducial support 112, either printed directly, applied as a label, or attached by another method. The tab 128a is connected to the fixed portion 128b by hinges 156 and can pivot between obstructive and non-obstructive positions.

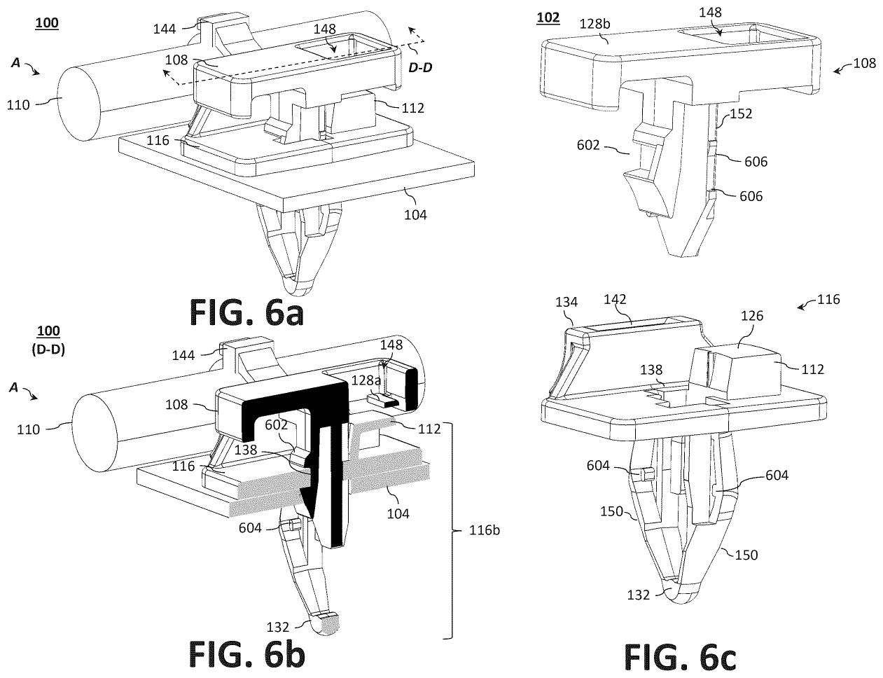

FIG. 6A illustrates a fastening system 100 configured to secure one or more second components relative to a first component by means of a fastener assembly 102 including a lock pin 108 and a base structure 116, in accordance with a third aspect of the present disclosure. The fastening system 100 is shown in a first assembled position. FIG. 6B illustrates a cross-sectional view of the fastener assembly 102 taken along cutline D-D of FIG. 6A, and FIG. 6C illustrates an exploded assembly view of the fastener assembly 102 corresponding to FIGS. 6A and 6B.

The fastener assembly 102 of FIGS. 6A through 6C is substantially the same as the fastener assembly 102 of FIGS. 2A through 2L, except for the mechanical interaction between the shank 152 and the fastener portion 116B. In this example, rather than positioning locking tabs on the base structure 116 to hold the lock pin 108 in place until the base structure 116 is inserted into the opening 106 of the first component 104, lock features are instead formed on the lock pin 108 itself. For instance, the illustrated lock pin 108 includes a locking tab 602 resiliently coupled to the fixed portion 128b and/or the shank 152, the locking tab 602 being configured to engage the base structure 116 to secure the base structure 116 and the lock pin 108 in a shipping position (Position A). As shown in the cross-sectional view of FIG. 6B, the locking tab 602 clips onto the base structure 116 at or adjacent to the grommet opening 138. The shank 152 may further include one or more ledges 606 (illustrated as ramps) positioned on an exterior surface of the shank 152 along its length. These ledges 606 are configured to engage one or more ridges 604 formed on an inner surface of each of the pair of resilient legs 150.

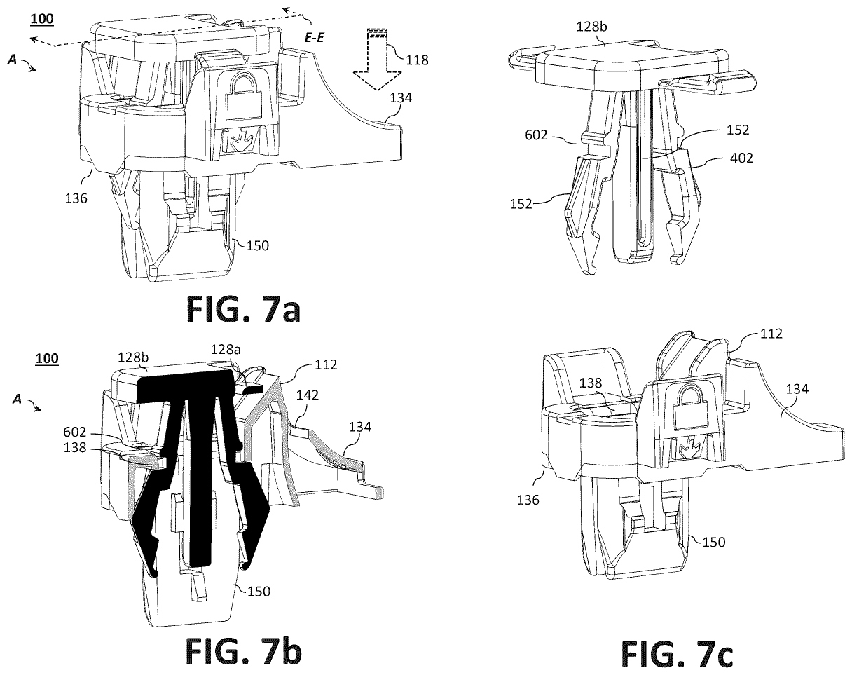

FIG. 7A illustrates a fastening system 100 configured to secure one or more second components relative to a first component by means of a fastener assembly 102 including a lock pin 108 and a base structure 116, in accordance with a fourth aspect of the present disclosure. The fastening system 100 is shown in a first assembled position. FIG. 7B illustrates a cross-sectional view of the fastener assembly 102 taken along cutline E-E of FIG. 7A, and FIG. 7C illustrates an exploded assembly view of the fastener assembly 102 corresponding to FIGS. 7A and 7B.

The fastener assembly 102 of FIGS. 7A through 7C is substantially the same as the fastener assembly 102 of FIGS. 4A through 4L, except for the mechanical interaction between the shank 152 and the fastener portion 116B. Similar to the embodiment of FIGS. 6A through 6C, rather than positioning locking tabs on the base structure 116 to hold the lock pin 108 in place until the base structure 116 is inserted into the opening 106 of the first component 104, lock features are instead formed on the lock pin 108. For example, the illustrated lock pin 108 includes a locking tab 602 coupled to each flexible arm 402, the locking tab 602 being configured to engage the base structure 116 to secure the base structure 116 and the lock pin 108 in the shipping position (Position A). As shown in the cross-sectional view of FIG. 7B, the locking tab 602 clips onto the base structure 116 at or adjacent to the grommet opening 138.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A fastening system configured to secure one or more second components to a first component, comprising:
a base structure defining a grommet portion and a carrier portion, the carrier portion including a fiducial support having an installation indicator; and
a lock pin comprising a shank and a head, the head including a fixed portion and a tab pivotally coupled to the fixed portion,
wherein the tab is movable between a first position and a second position relative to the installation indicator, and
wherein the tab is configured to pivot upon engagement with the fiducial support during advancement of the lock pin to a fully seated position, thereby allowing the installation indicator to be read by a visual quality system.

2. The fastening system of claim 1, wherein the tab is coupled to the fixed portion via one or more film hinges.

3. The fastening system of claim 1, wherein in the first position, the tab at least partially covers the installation indicator to indicate that the lock pin is not fully seated.

4. The fastening system of claim 1, wherein the base structure comprises one or more flex tab features configured to engage a window in the first component, the flex tab features deflecting during insertion and returning to an extended position to retain the base structure.

5. The fastening system of claim 1, wherein the fiducial support is positioned at an angle relative to the carrier portion to optimize detection of the installation indicator by the visual quality system.

6. The fastening system of claim 1, wherein the tab is coupled along an exterior edge of the fixed portion.

7. The fastening system of claim 1, wherein movement of the tab to the second position provides a visual confirmation of proper installation of the lock pin relative to the base structure.

8. The fastening system of claim 1, further comprising a strap and a strap opening in the carrier portion, the strap configured to secure the one or more second components to the carrier portion.

9. A lock pin assembly for use with a base structure comprising a fiducial support carrying an installation indicator, the lock pin assembly comprising:
a shank;
a head including a fixed portion and a tab pivotally coupled to the fixed portion; and
wherein the tab is movable between a first position and a second position relative to the installation indicator, and
wherein the tab is configured to pivot upon engagement with the fiducial support during advancement of the lock pin to a fully seated position, thereby allowing the installation indicator to be read by a visual quality system.

10. The lock pin assembly of claim 9, wherein the head further comprises a pair of flexible arms extending from the shank, each flexible arm having a first notch and a second notch configured to engage a pawl on the base structure to maintain the lock pin in one of a shipping position and a fully installed position.

11. The lock pin assembly of claim 9, wherein the tab is configured to pivot upon engagement with the fiducial support.

12. The lock pin assembly of claim 9, wherein the tab is pivotable about a pivot axis formed along an exterior edge of the fixed portion.

13. The lock pin assembly of claim 9, wherein the installation indicator comprises a barcode, QR code, or another machine-readable symbol.

14. The lock pin assembly of claim 9, wherein the fiducial support is a block-shaped structure at least partially received by a window in the fixed portion of the head of the lock pin.

15. A fastening system configured to secure one or more second components to a first component, comprising:
a base structure comprising a carrier portion and one or more pawls;
a lock pin comprising a shank and a head, the head including a fixed portion, a tab pivotally coupled to the fixed portion, and a pair of flexible arms extending from the shank, each flexible arm having a first notch and a second notch configured to engage the pawl to maintain the lock pin in a shipping position and a fully installed position, respectively; and
wherein the tab is movable between a first obstructive position and a second non-obstructive position relative to an installation indicator mounted on a fiducial support of the carrier portion, the tab pivoting upon engagement with the fiducial support as the lock pin is advanced to a fully seated position.

16. The fastening system of claim 15, wherein the flexible arms are configured to deflect inward to disengage the pawl from the first notch during advancement of the lock pin.

17. The fastening system of claim 15, wherein the pawl engages the second notch of the flexible arms to lock the lock pin in the fully installed position.

18. The fastening system of claim 15, wherein the fiducial support is positioned to stabilize the tab and maintain a consistent angle of the installation indicator for visual detection.

19. The fastening system of claim 15, wherein improper seating of the lock pin prevents the tab from fully pivoting, resulting in the installation indicator being at least partially obstructed.

20. The fastening system of claim 15, wherein the base structure further comprises a grommet portion defining a grommet opening configured to receive the shank of the lock pin.
